(19) United States
(12) Patent Application Publication
(10) Pub. No.: US 2014/0053773 A1
(43) Pub. Date: Feb. 27, 2014

(54) GLUING DEVICE FOR ASSEMBLING LENS MODULE

(71) Applicant: HON HAI PRECISION INDUSTRY CO., LTD., New Taipei (TW)

(72) Inventor: CHIEN-CHUN WANG, New Taipei (TW)

(73) Assignee: HON HAI PRECISION INDUSTRY CO., LTD., New Taipei (TW)

(21) Appl. No.: 13/721,037

(22) Filed: Dec. 20, 2012

(30) Foreign Application Priority Data
Aug. 24, 2012 (TW) 101130748

(51) Int. Cl. B05B 17/00

(52) U.S. Cl. CPC B05B 17/00
USPC 118/300

(57) ABSTRACT

A gluing device includes a supporting member, a gluing syringe, a first air compressor, and a second air compressor. The supporting member includes a loading surface. The gluing syringe is positioned above the loading surface and includes a main portion and a glue outlet portion. The main portion contains glue. Glue is expelled from the outlet portion. The first air compressor compresses the glue out of the main portion through the glue outlet portion. The second air compressor vaporizes the expelled glue through the glue outlet.

### BACKGROUND

1. Technical Field

The present disclosure relates to gluing devices and, particularly, to a gluing device for assembling a lens module.

2. Description of Related Art

When assembling a lens module, an optical element such as a lens may have an interference fit in a lens barrel. Then glue is applied to a joint portion between the optical element and the lens barrel such that the optical element is firmly fixed in the lens barrel. However, being limited by manufacturing precision, a slightly undersize optical element may have what is substantially a clearance fit in the lens barrel, which makes the optical element unstable in the lens barrel and thus liable to tilting when glue is applied.

Therefore, it is desirable to provide a gluing device, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic view of a gluing device for assembling a lens module, according to an exemplary embodiment.

FIG. 2 is a schematic view of a loading assembly of the gluing device of FIG. 1.

### DETAILED DESCRIPTION

Embodiments of the present disclosure will be described with reference to the drawings.

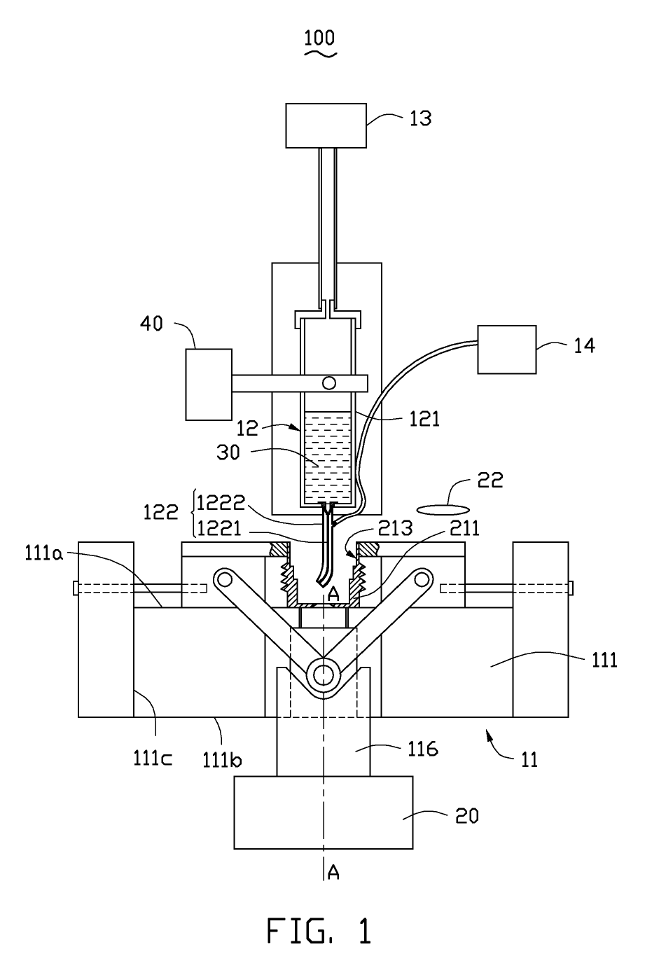

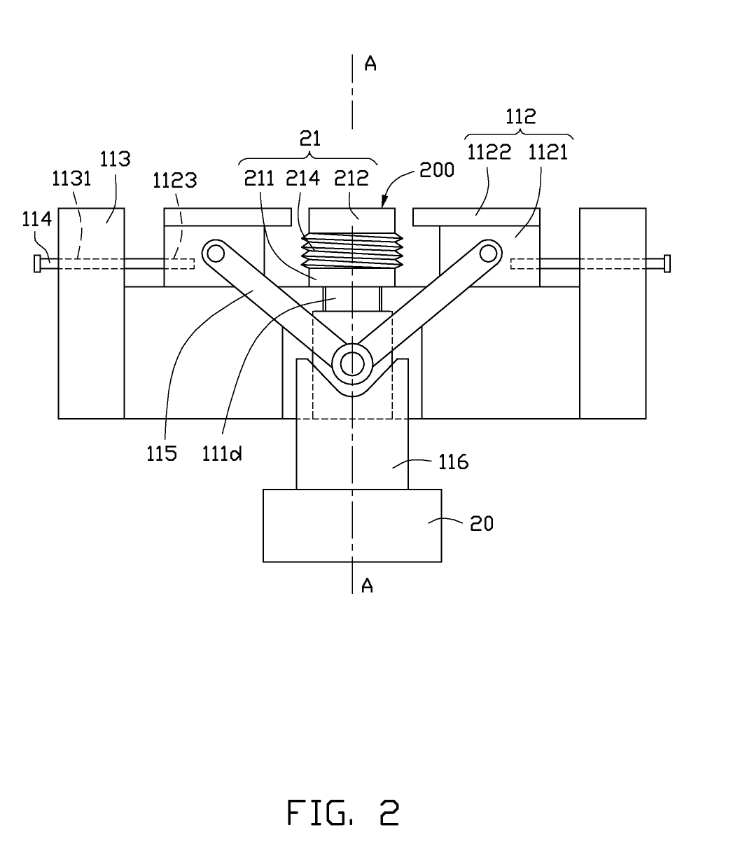

Referring to FIGS. 1 and 2, a gluing device 100 for assembling a lens module 200, is shown.

The lens module 200 includes a lens barrel 21 and at least one optical element 22. The lens barrel 21 is a hollow cylinder and includes a first end 211 and a second end 212 opposite to the first end 211. An annular lip portion (not labeled) extends inwardly from the first end 211. The second end 212 is open. The lens barrel 21 includes a stepped inner surface 213 and outer threads 214 formed on the outer surface and located between the first end 211 and the second end 212. The optical element 22 is a circular lens. In alternative embodiments, the optical element 22 can be an infrared filter, an aperture mechanism, or the like.

The gluing device 100 includes a loading assembly 11, a gluing syringe 12, a first air compressor 13, and a second air compressor 14.

The loading assembly 11 includes a supporting member 111, two sliding blocks 112, two mounting plates 113, two bolts 114, two connection rods 115, and a shaft portion 116. The supporting member 111 is substantially cuboid and includes a loading surface 111a, a bottom surface 111b opposite to the loading surface 111a, and a pair of side surfaces 111c perpendicularly connecting with the loading surface 111a. The supporting member 111 defines a circular blind hole 111d in the middle of the loading surface 111a. The blind hole 111d is symmetrical about a center axis AA of the supporting member 111 and a diameter of the blind hole 111d is less than an outer diameter of the lens barrel 21.

The sliding blocks 112 are positioned on the loading surface 111a adjacent to the blind hole 111d and are always symmetrical about the center axis AA. Each sliding block 112 includes a sliding portion 1121 and a clamping portion 1122. The sliding portion 1121 is in contact with the loading surface 111a. Each sliding portion 1121 defines a first screw hole 1123 extending along a direction parallel to the loading surface 111a. The first screw hole 1123 is a blind hole and a first screw hole 1123 is defined at a side of each sliding portion 1121 facing away from the other sliding block 112. The clamping portion 1122 is positioned on the sliding portion 1121 and spaced from the loading surface 111a. Two clamping portions 1122 of the two sliding blocks 112 extend towards and opposite to each other.

Each mounting plate 113 is mounted to a side surface 111c, that is, the two mounting plates 113 are mounted on the supporting member 111, and the two sliding blocks 112 are positioned between the two mounting plates 113. Each sliding block 112 is adjacent to a mounting plate 113. In alternative embodiments, the mounting plates 113 can be integrally formed with the supporting member 111. Each mounting plate 113 defines a second screw hole 1131 extending parallel to the loading surface 111a. The second screw hole 1131 is a through hole and aligns with the first screw hole 1123 of a corresponding adjacent sliding block 112. Each mounting plate 113 is connected to the adjacent sliding block 112 through a corresponding bolt 114. Each bolt 114 passes through a second screw hole 1131 to engage with a first screw hole 1123. By rotating the bolts 114, the bolts 114 can move the sliding blocks 112 towards or away from each other. In alternative embodiments, each sliding block 112 is connected to a motor. The motor drives each sliding block 112 to slide synchronously towards or away from the other sliding block 112.

One end of each connection rod 115 is rotatably connected to the sliding portion 1121 of a corresponding slide block 112 and the other end is rotatably connected to the other connection rod 115. A total length of the two connection rods 115 is greater than a distance between the two mounting plates 113.

The shaft portion 116 extends from the middle of the bottom surface 111b. The shaft portion 116 is coaxial with the blind hole 111d and is connected to a first motor 20. The first motor 20 rotates the supporting member 111 about the center axis AA.

The gluing syringe 12 is positioned above the loading surface 111a and includes a cylindrical hollow main portion 121 and a glue outlet portion 122. The main portion 121 contains glue 30. An outer surface of the main portion 121 is connected to a second motor 40. The second motor 40 drives the gluing syringe 12 to move perpendicularly toward or away from the loading surface 111a. The glue outlet portion 122 is connected to one end of the main portion 121 and includes a glue outlet pipe 1221 and an air outlet pipe 1222. One end of the glue outlet pipe 1221 is connected to and in communication with the main portion 121 such that the glue 30 can be expelled from the glue outlet pipe 1221. The air outlet pipe 1222 is sleeved outside the glue outlet pipe 1221. One end of the air outlet pipe 1222 is connected to the main portion 121 but is not in communication with the main portion 121. The other end of the air outlet portion 1222 is aligned with the other end of the glue outlet pipe 1221 away from the main portion 121.

The first air compressor 13 is connected to the other end of the main portion 121 away from the glue outlet portion 122 and is in communication with the main portion 121. The first air compressor 13 generates compressed air to force the glue 30 from the main portion 121 and out through the glue outlet pipe 1221.

The second air compressor 14 is connected to the air outlet pipe 1222 between two ends of the air outlet pipe 1222 and is in communication with the air outlet pipe 1222. The second air compressor 14 generates compressed air to transform the glue 30 into very small droplets (vaporized glue) as the glue 30 is being expelled through the glue outlet pipe 1221.

When assembling the optical element 22 in the lens barrel 22, the lens barrel 21 is positioned on the loading surface 111a with the first end 211 being attached on the loading surface 111a. An optical axis of the lens barrel 21 is aligned with the center axis AA. The blind hole 111d is in communication with the lens barrel 21. The bolts 114 are rotated, or the motor is activated, to slide the sliding blocks 112 towards each other. The second end 212 of the lens barrel 10 is clamped by and between the two clamping portions 1122. The second motor 40 drives the glue syringe 12 down to the loading surface 111a, such that the glue outlet portion 122 is inserted into the lens barrel 12. The glue outlet portion 122 then faces the inner surface 213. The first air compressor 13 and the second air compressor are turned on to expel the glue 30 through the glue outlet pipe 1221 as vaporized glue. The first motor 20 drives the supporting member 111 to rotate about the center axis AA such that the lens barrel 21 is rotated by the supporting member 111 about the center axis AA. The second motor 40 adjusts the height of the glue syringe 12 within the lens barrel 12, such that the glue 30, as vaporized glue, is uniformly sprayed on the inner surface 213. Then the optical element 22 is received in the lens barrel 21 and adheres to the inner surface 213 by virtue of the glue 30 sprayed on the inner surface 213. The blind hole 111d collects any excess of glue 30.

The gluing device 100 sprays the glue 30 on the inner surface 213, then the optical element 22 can adhere to the inner surface 213. No pre-positioning of the optical element 22 in the lens barrel 21 is required, such that the optical element 22 is given no opportunity to tilt.

In alternative embodiments, the first motor 20 and the second motor 40 can be omitted. The supporting member 111 can be manually rotated about the center axis AA and the glue syringe 12 can be manually moved down to and up from the loading surface 111a such that the glue 30 is uniformly sprayed on the inner surface 213.

In alternative embodiments, the two connection rods 115 can be omitted.

In alternative embodiments, the glue outlet portion 122 only includes the glue outlet pipe 1221. The second air compressor 14 is connected directly into the glue outlet pipe 1221.

The above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A gluing device, comprising:
a supporting member comprising a loading surface;
a gluing syringe positioned above the loading surface, the gluing syringe comprising a main portion and a glue outlet portion, the main portion being hollow and configured for containing glue, the outlet portion being connected to and in communication with the main portion, the outlet portion being configured for expelling the glue;
a first air compressor connected to the main portion and configured for generating compressed air to force the glue from the main portion and out through the glue outlet portion; and
a second air compressor connected to and in communication with the glue outlet portion, the second air compressor being configured for generating compressed air to transform the glue into small droplets when the glue is expelled through the glue outlet portion.

2. The gluing device as claim in claim 1, wherein the supporting member defines a circular blind hole in a middle of the loading surface.

3. The gluing device as claim in claim 2, wherein the supporting member comprises a bottom surface and a shaft portion extending from the bottom surface, the shaft portion is coaxial with the blind hole, the shaft portion is connected to a first motor, the first motor is configured to rotate the supporting member.

4. The gluing device as claim in claim 3, wherein the main portion is connected to a second motor, the second motor is configured to drive the glue syringe perpendicularly toward the loading surface or away from the loading surface.

5. The gluing device as claim in claim 1, wherein the glue device comprises two sliding blocks positioned on the loading surface, the sliding blocks are capable of sliding toward or away from each other.

6. The gluing device as claim in claim 5, wherein the gluing device comprises two mounting plates and two bolts, each mounting plate is mounted on a respective side surface of the supporting member, the sliding blocks are positioned between the two mounting plates, each sliding block is adjacent to a corresponding mounting plate, each sliding block defines a first screw hole, each mounting plate defines a second screw hole, each slide block is connected to a corresponding adjacent mounting plate through a corresponding bolt engaging with the first screw hole and the second screw hole.

7. The gluing device as claim in claim 6, wherein the first screw hole is a blind hole and the second screw hole is a through hole.

8. The gluing device as claim in claim 6, wherein the gluing device comprises two connection rods, one end of each connection rod is rotatably connected to a corresponding sliding block and the other end is rotatably connected the other connection rod.

9. The gluing device as claim in claim 1, wherein the glue outlet portion comprises a glue outlet pipe and an air outlet pipe, one end of the glue outlet pipe is connected to and in communication with the main portion, the air outlet pipe is sleeved outside the glue outlet pipe, one end of the air outlet pipe is connected to the main portion but is not in communication with the main portion.

10. The gluing device as claim in claim 9, wherein the other end of the air outlet pipe is aligned with the other end of the glue outlet pipe away from the main portion.
